(19) United States
(12) Patent Application Publication
(10) Pub. No.: US 2023/0349398 A1
(43) Pub. Date: Nov. 2, 2023

(54) SYSTEMS AND METHODS FOR DYNAMIC CONTROL OF WORK VEHICLES

(71) Applicant: CNH Industrial America LLC, New Holland, PA (US)

(72) Inventor: Joshua D. Zimmerman, Willow Springs, IL (US)

(21) Appl. No.: 17/732,726

(22) Filed: Apr. 29, 2022

(51) Int. Cl. F15B 13/02; E02F 9/22

(52) U.S. Cl. CPC F15B 13/02; E02F 9/2235; F15B 2211/31

(57) ABSTRACT

A hydraulic control system for a work vehicle includes one or more processors configured to receive an indication of a pump flow provided by a pump of the hydraulic control system. The one or more processors are also configured to receive an additional indication of a current input position of an input device of the hydraulic control system. The one or more processors are further configured to apply a dynamic valve map to control a valve position of a valve of the hydraulic control system based on the pump flow and the current input position of the input device.

### BACKGROUND

This disclosure relates generally to work vehicles, and more specifically to systems and methods for dynamic control of work vehicles.

A work vehicle, such as a tractor or a skid steer, may be configured to couple to an attachment assembly (e.g., a loader assembly; a dozer assembly) to perform a work function (e.g., a loader function; a dozer function). The attachment assembly may be powered by a hydraulic circuit, which may include a hydraulic pump that is configured to pump a hydraulic fluid from a fluid source to an actuator that is configured to drive movement of the attachment assembly. The hydraulic circuit may also include a valve in line between the hydraulic pump and the actuator. A displacement of the valve may be controlled by an operator via an input at an operator controller (e.g., joystick) to thereby enable the operator to define a flow of the hydraulic fluid through the valve (e.g., from the hydraulic pump, through the valve, and to the actuator).

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the disclosure. Indeed, the disclosure may encompass a variety of forms that may be similar to or different from the embodiments set forth below.

In some embodiments, a hydraulic control system for a work vehicle includes one or more processors configured to receive an indication of a pump flow provided by a pump of the hydraulic control system. The one or more processors are also configured to receive an additional indication of a current input position of an input device of the hydraulic control system. The one or more processors are further configured to apply a dynamic valve map to control a valve position of a valve of the hydraulic control system based on the pump flow and the current input position of the input device.

In some embodiments, a hydraulic control system for a work vehicle includes one or more processors configured to receive an indication of a pump flow provided by a pump of the hydraulic control system, determine a maximum valve position that corresponds to the pump flow, and set the maximum valve position to correspond to a maximum input position. The one or more processors are also configured to set a minimum valve position to correspond to a minimum input position, and set a line that maps a valve position across different input positions, wherein the line extends between the maximum valve position and the minimum valve position. The one or more processors are further configured to receive a current input position for an input device, and control a valve according to the line and the current input position.

In some embodiments, a method of operating a hydraulic control system for a work vehicle includes receiving, at one or more processors, an indication of a pump flow being provided by a pump of the hydraulic control system. The method also includes receiving, at the one or more processors, an additional indication of a current input position of an input device of the hydraulic control system. The method further includes applying, using the one or more processors, a dynamic valve map to control a valve position of a valve of the hydraulic control system based on the pump flow and the current input position of the input device.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of a work vehicle, in accordance with an embodiment of the present disclosure;

FIG. 2 is a schematic diagram of a hydraulic circuit of the work vehicle shown in FIG. 1, in accordance with an embodiment of the present disclosure;

FIG. 3 illustrates one example of a static valve map and one example of a dynamic valve map that may be used to control the hydraulic circuit shown in FIG. 2; and

FIG. 4 is a flow chart of a method for operating a work vehicle having the hydraulic circuit shown in FIG. 2 using the dynamic valve map shown in FIG. 3, in accordance with an embodiment of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

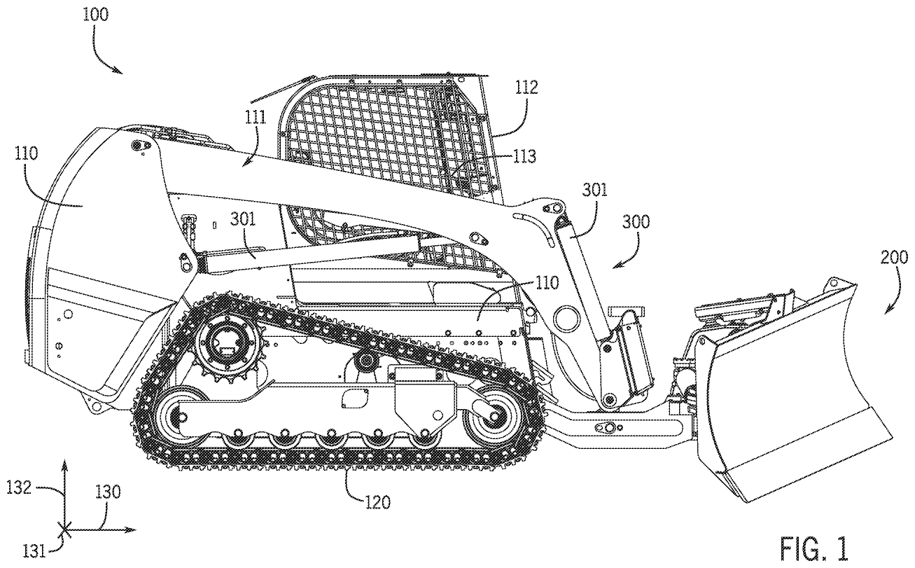

FIG. 1 is a side view of an embodiment a work vehicle 100 that includes a frame 110 supported on tracks 120. The work vehicle 100 includes an engine within the frame 110, and the engine is configured to provide power to drive rotation of the tracks 120 to move the work vehicle 100 over ground. As shown, the work vehicle 100 may be described with reference to a longitudinal axis 130, a lateral axis 131, and a vertical axis 132. The longitudinal axis 130 may also correspond to a forward direction of travel for the work vehicle 100.

As shown, the work vehicle 100 may include or be configured to couple to an attachment assembly 200 (e.g., implement). The attachment assembly 200 may be powered and/or driven via a hydraulic control circuit 300 (e.g., hydraulic control system), which includes one or more actuators 301 (e.g., hydraulic cylinders). In particular, the one or more actuators 301 be configured to drive rotation of the attachment assembly 200 relative to the frame 110 of the work vehicle 100. In some embodiments, the work vehicle includes one or more arms 111 that support the attachment assembly 200. In such cases, the one or more actuators 301 may extend between the frame 110 and the one or more arms 111. Then, the one or more actuators 301 may lengthen and retract drive rotation of the one or more arms 111 and the attachment assembly 200 coupled to the one or more arms 111 relative to the frame 110 of the work vehicle 100. In some embodiments, the one or more actuators 301 may extend between the one or more arms 111 and the attachment assembly 200. In such cases, the one or more actuators 301 may extend between the one or more arms 111 and the attachment assembly 200. Then, the one or more actuators 301 may lengthen and retract to drive rotation of the attachment assembly 200 relative to the one or more arms 111 and the frame 110. It should be appreciated that the work vehicle 100 may include two arms 111, one on each lateral side of the work vehicle 100 (e.g., opposite lateral sides of the work vehicle 100). Furthermore, the one or more actuators 301 may include a first pair of actuators that each extend between the frame 110 and the one or more arms 111 (with one on each lateral side of the work vehicle 100). Additionally or alternatively, the one or more actuators 301 may include a second pair of actuators that each extend between the one or more arms 111 and the attachment assembly 200 (with one on each lateral side of the work vehicle 100). In any case, the hydraulic control circuit 300 may be configured to enable movement of the attachment assembly 200 in various ways, such as to raise and lower relative to the ground and/or to tilt or rotate about the lateral axis 131.

While the work vehicle 100 includes the tracks 120 to facilitate discussion, it should be appreciated that the work vehicle 100 may include wheels or another appropriate rolling assembly to move the work vehicle 100 over the ground. Additionally, while the work vehicle 100 is shown as a skid steer to facilitate discussion, it should be appreciated that the work vehicle 100 may be any type of work vehicle, such as a tractor, a harvester, any other work machine, any other construction machine, and/or any other agricultural machine. Furthermore, while the attachment assembly 200 is shown as a dozer blade, it should be appreciated that the attachment assembly may be asphalt miller, a bale spear, a barrier lift, a bucket, a backhoe, a cold planer, a concrete claw, demolition equipment, a dozer blade, a grapple bucket, a harley rake, a hydraulic brush cutter, a forestry mulcher, a pallet fork, a post driver, a rock saw, a root grapple, a rotary broom, a stump grinder, a tiller, a tree shear, a trench digger, or a vibratory roller, among others. Furthermore, the attachment assembly 200 may be interchangeable such that the work vehicle 100 may be used with different attachment assemblies at different times (e.g., a dozer blade over a first time period to conduct dozer operations; a bucket over a second time period to conduct loader operations). Thus, the hydraulic control circuit 300 may drive the movement of the different attachment assemblies at different times.

As shown, the work vehicle 100 may include a cab 112 that is configured to house an operator (e.g., human operator). The cab 112 may also include an input device 113, which may be any type of input device that enables the operator to provide inputs (e.g., input commands) for the work vehicle. For example, the input device 113 may include a joystick, a lever, a push button, a touchscreen, or any combination thereof. It should be appreciated that the input device 113 may be positioned at any suitable location about the work vehicle 100. Furthermore, the work vehicle 100 may be an autonomous vehicle, and in such cases, the input device 113 may be located remotely from the work vehicle 100. For example, the input device 113 may be located in a control center station adjacent to a work site being worked by the worked vehicle 100 and/or remotely from the work site being worked by the work vehicle 100.

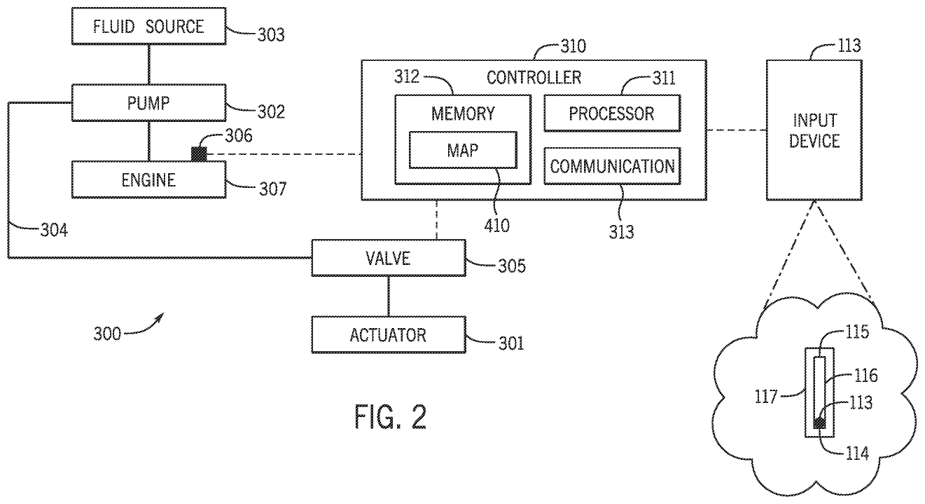

FIG. 2 is a schematic diagram of the hydraulic control circuit 300 of the work vehicle 100 shown in FIG. 1, in accordance with an embodiment of the present disclosure. As shown, the hydraulic control circuit 300 includes the actuator 301 (e.g., one of the one or more actuators 301 shown in FIG. 1). The hydraulic control circuit 300 also includes a pump 302 (e.g., hydraulic pump) that is configured to pump a fluid from a fluid source 303 (e.g., tank), through a fluid conduit 304, and to a valve 305. The valve 305 is configured to adjust (e.g., regulate) a flow (e.g., flow rate) of the fluid to the actuator 301. It should be appreciated that the valve 305 may be any suitable type of control valve (e.g., spool valve).

The hydraulic control circuit 300 also includes a controller 310 (e.g., electronic controller) that includes a processor 311 and a memory device 312. The controller 310 is configured to receive an indication of a pump flow (e.g., flow rate; available flow from the pump 302). As used herein, “the pump flow” may refer to the available flow from the pump 302, which is a maximum available flow from the pump 302 or a pump flow limit from the pump 302. The controller 310 may receive the indication of the pump flow from a pump flow sensor 306 that is configured to generate sensor data indicative of the pump flow. The pump flow sensor 306 may be any suitable type of sensor, such as a flow meter along the fluid conduit 304, a swash plate sensor, a pump speed sensor, and/or an engine speed sensor (as shown in FIG. 2) because a pump speed and the pump flow may vary with an engine speed of an engine 307 of the work vehicle. For example, in certain embodiments, the pump flow sensor 306 is the engine speed sensor. Then, the controller 310 receives signals indicative of the engine speed of the engine 307 from the pump flow sensor 306. Then, the controller 310 determines the pump flow based on the engine speed of the engine 307, wherein the pump flow is the available pump flow from the pump 302 (e.g., a maximum available pump flow from the pump 302). Indeed, in certain embodiments, the hydraulic control circuit 300 may not include (or at least, may not utilize) any sensor that measures the actual flow from the pump 302 and/or other features at the pump 302. Instead, the hydraulic control circuit 300 may carry out the techniques disclosed herein using the signals indicative of the engine speed of the engine 307 to calculate the available pump flow from the pump 302 without any inputs of the actual pump flow from the pump 302 and/or other inputs measured at the pump 302. However, it should be appreciated that the hydraulic control circuit 300 may additionally or alternatively carry out the techniques disclosed herein using inputs of the actual pump flow from the pump 302 (e.g., measured via the flow meter along the fluid conduit 304) and/or other inputs measured at the pump 302 (e.g., swash plate sensor).

The controller 310 is also configured to receive an input (e.g., input command) from the input device 113. As noted herein, the input device 113 may be a joystick or other suitable type of input device that may be manipulated by the operator to generate the input. For example, the operator may adjust an input position of the input device 113, such as by moving the input device 113 between a minimum input position 114 (e.g., first input position) and a maximum input position 115 (e.g., second input position; within a slot 116 formed in a dashboard or console 117 of the work vehicle). The minimum input position 114 may be a minimum, or first, limit position of the input device 113, and the maximum input position 115 may be a minimum, or second, limit position of the input device 113.

The controller 310 may control (e.g., set) a valve position (e.g., displacement) of the valve 305 based on the input position of the input device 113. Thus, the valve position of the valve 305 varies as the operator manipulates the input device 113. In this way, the valve position of the valve 305 varies to generally provide less fluid flow as the operator moves the input device 113 toward the minimum input position 114 and more fluid flow as the operator moves the input device 113 toward the maximum input position 115. However, it is presently recognized that this may occur only as long as a valve flow (e.g., flow rate; a commanded valve flow through the valve 305) is less than the pump flow. That is, the valve flow is independent of the pump flow as long as the valve flow is less than the pump flow. To address this, the present embodiments utilize a dynamic valve map to enhance the operations of the work vehicle, as discussed in more detail herein.

The controller 310 may include any suitable computer device, such as a general-purpose personal computer, a laptop computer, a tablet computer, a mobile computer, or the like that is configured in accordance with present embodiments. The processor 311 may be any type of computer processor or microprocessor capable of executing computer-executable code. The processor 311 may also include multiple processors that may perform the various operations described herein. The memory device 312 may be any suitable article of manufacture that can serve as media to store processor-executable code, data, or the like. The article of manufacture may represent computer-readable media (e.g., any suitable form of memory or storage) that may store the processor-executable code used by the processor 311 to perform various techniques disclosed herein. The memory device 312 may represent non-transitory computer-readable media (e.g., any suitable form of memory or storage). It should be noted that non-transitory merely indicates that the media is tangible and not a signal. The controller 310 may include a communication component 313 that facilitates wired or wireless communication between the controller 310 and various other computing systems.

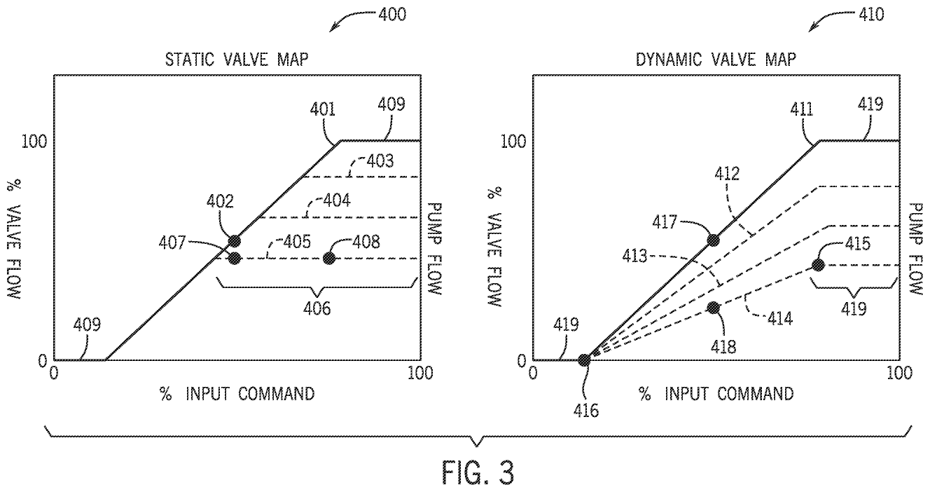

FIG. 3 illustrates one example of a static valve map 400 and one example of the dynamic valve map 410 that may be used to control the hydraulic control circuit 300 shown in FIG. 2. As shown, the static valve map 400 includes a valve flow (e.g., as a percentage) on a y-axis and an input command (e.g., as a percentage) on an x-axis. The static valve map 400 illustrates that as long as the valve flow is less than the pump flow, the operator may be able to control the valve with the input command to effectively adjust the valve flow through a range of the input device (e.g., a full range, such as a substantially full range, between the minimum input position to the maximum input position) according to a first line 401. For example, as represented by a first point 402 along the first line 401, upon the operator manipulating the input device to provide the input command of 55 percent while the valve flow is less than the pump flow, the valve flow may be 55 percent.

However, once the pump flow decreases below the valve flow (e.g., the commanded valve flow), the valve flow is dependent on the pump flow. Then, further adjustments of the input device to increase the input command will have no effect on the valve flow and the operator may experience an inoperable range of the input device (e.g., a dead zone for the input device). In the static valve map 400, a second line 403, a third line 404, and a fourth line 405 represent respective inoperable ranges of the input device at different pump flows. As shown, the fourth line 405 represents a respective inoperable range 406, and the respective inoperable ranges decrease as the pump flow increases. For example, as represented by a second point 407 along the fourth line 405, upon the operator manipulating the input device to provide the input command of 55 percent while the pump flow is 50 percent and is less than the valve flow, the valve flow may be 50 percent and correspond to the pump flow. Moreover, further adjustments of the input device to increase the input command will have no effect on the valve flow (e.g., the valve flow will remain at 50 percent, as this is the available pump flow). As another example, as represented by a third point 408 along the fourth line 405, upon the operator manipulating the input device to provide the input command of 80 percent while the pump flow is 50 percent and is less than the valve flow, the valve flow will remain at 50 percent and correspond to the pump flow. Thus, in this case, the operator may not observe any movement of the one or more actuators and/or the attachment assembly as the operator manipulates the input device from an intermediate input position (e.g., midway between the minimum input position and the maximum input position) toward the maximum input position.

In other words, with reference to the static valve map 400, if the pump flow is limited to half of a maximum valve flow and if a linear relationship between the valve flow and the input command is applied, then zero to 50 percent of the input command controls zero to 50 percent of the maximum valve flow. However, because the valve cannot allow more flow than what is provided via the pump flow, 50 to 100 percent of the input command will still only provide 50 percent of the maximum valve flow. This results in the large respective inoperable range 406 that may be distracting to the operator and/or reduce a resolution that may be desirable to carry out precise movements. Indeed, often the operator attempts to carry out precise movements and/or fine control (e.g., of the attachment assembly) while the work vehicle is at low speeds (which may automatically result in low pump flow in certain work vehicles where the pump speed and the pump flow are related to the engine speed). Thus, having the inoperable range increase as the pump flow decreases provides less resolution for the input device at a time when the operator is most likely to want full resolution for the input device to successfully, efficiently carry out the precise movements.

As noted, the first line 401 is considered to enable the operator to effectively adjust the valve flow through the full range (e.g., the substantially full range) of the input device. The full range may include from the minimum input position that corresponds to zero percent input command to the maximum input position that corresponds to 100 percent input command (e.g., the first line 401 has an upward slope along its entire length from the zero percent input command to the 100 percent input command). Or, as shown, the full range may include transition portions 409 (e.g., small inoperable ranges; from zero percent input command to 5 or 10 percent input command; from 90 or 95 percent input command to 100 percent input command) over which manipulation of the input device may not affect the valve flow. In other words, the valve may allow no flow or a minimal flow from zero percent input command to 5 or 10 percent input command and may allow a maximum flow from 90 or 95 percent input command to 100 percent input command. These transition portions 409 may be small enough so as to not cause undue distraction to the operator; however, the transition portions 409 are smaller than the respective inoperable ranges represented by lines 403, 404, 405.

As discussed herein, the static valve map 400 may present certain challenges in the operation of the work vehicle. To address these challenges, certain embodiments relate to generating and to utilizing the dynamic valve map 410 to change (e.g., remap) a relationship between the valve flow and the input command based on the pump flow. The dynamic valve map 410 includes a valve flow (e.g., as a percentage) on a y-axis and an input command (e.g., as a percentage) on an x-axis. As shown, the dynamic valve map 410 includes multiple discrete lines that represent the relationship between the valve flow and the input command at different pump flows. For example, a first line 411 represents the relationship between the valve flow and the input command at a first pump flow (e.g., above the commanded valve flow; a maximum pump flow), a second line 412 represents the relationship between the valve flow and the input command at a second pump flow (e.g., lower than the first pump flow), a third line 413 represents the relationship between the valve flow and the input command at a third pump flow (e.g., lower than the second pump flow), and a fourth line 414 represents the relationship between the valve flow and the input command at a fourth pump flow (e.g., lower than the third pump flow). It should be appreciated that the dynamic valve map 410 may include any number of discrete lines (e.g., more than 4, 5, 6, 7, 8, 9, 10, 20, 30).

In some embodiments, the controller may receive an indication of the pump flow (e.g., the pump flow at a current time; from the pump flow sensor) and access the dynamic valve map 410 (e.g., from the memory device). Then, the controller may identify and/or use the discrete line that corresponds to a respective pump flow that is closest to the pump flow. In such cases, the controller may generate the dynamic valve map 410 over time for the work vehicle (e.g., during work operations at the work site; continuously, periodically, and/or responsively updated during the work operations at the work site), or the controller may receive and store the dynamic valve map 410 (e.g., generated during manufacturing based on empirical data and/or modeled data). The dynamic valve map 410 may be unique to the work vehicle and/or may be unique to each type of work vehicle (e.g., one for a certain model of a skidsteer, one for a certain model of a tractor). It should also be appreciated that the discrete lines may also merely represent examples to facilitate discussion and that the controller may dynamically generate respective lines (e.g., curves) in real-time (e.g., substantially real-time) each time the work vehicle performs work operations at the work site. In particular, the controller may dynamically generate the respective lines in real-time according to the techniques set forth herein.

In any case, to generate the dynamic valve map 410 and/or to dynamically generate the lines that relate the valve flow to the input command based on the pump flow, the controller may receive an indication of the pump flow provided by the pump of the hydraulic circuit. The controller may then determine a valve position that corresponds to the pump flow (e.g., the percent valve flow; allows the pump flow; matches the pump flow; not less than and not greater than the pump flow; via a lookup table stored in a memory device), and the controller may then assign the valve position as a maximum valve position of the valve (e.g., a maximum valve flow of the valve; a first valve flow). The controller may then set the maximum valve position of the valve to correspond to the maximum input position of the input device (e.g., the maximum input command of the input device, including substantially the maximum input position of the input device, such as 90 or 95 percent input command of the input device). The controller may then set a minimum valve position for the valve (e.g., a minimum valve flow of the valve; a second valve flow) to correspond to the minimum input position of the input device (e.g., the minimum input command of the input device, including substantially the minimum input position of the input device, such as 5 or 10 percent input command of the input device). As one non-limiting example, with reference to the dynamic valve map 410, the controller may determine a first point 415 (e.g., y-coordinate, the valve flow that corresponds to the pump flow; x-coordinate, the maximum input command, such as 90 percent). The controller may also determine a second point 416 (e.g., y-coordinate, the minimum valve flow; x-coordinate, the minimum input command, such as 5 percent).

The controller may then generate the line that relates the valve flow to the input command, wherein the line extends between the maximum valve position (e.g., the maximum valve flow) and the minimum valve position (e.g., the minimum valve flow). With reference to the above-noted example and the dynamic valve map 410, the controller may generate the fourth line 414 that extends from the first point 415 to the second point 416. It should be appreciated that these steps (e.g., to set the first point, the second point, and the line) may be repeated across different pump flows.

Furthermore, the lines may be linear, curved, or have any suitable shape. In some embodiments, the lines may have corresponding shapes, but are linearly extended and reduced relative to one another. In some embodiments, the lines may vary in curvature and/or shape based on the pump flow (e.g., some lines may be linear, some lines may be curved) to provide different resolutions through different ranges of the input device across the different pump flows. In some embodiments, the operator may not be aware of the dynamic mapping process being carried out by the controller (e.g., there are no displayed or visible outputs to the operator). However, in other embodiments, the controller may provide an output (e.g., displayed output) to alert the operator that the work vehicle is in a low-speed mode with the dynamic mapping process. The displayed output may include a representation of the dynamic valve map 410 (or portion of the dynamic valve map 410, such as a current line being applied to control the hydraulic control circuit). In some embodiments, the operator may be able to provide additional inputs to select and/or to adjust the dynamic valve map 410, such as additional inputs of preferences related to the lines and/or corresponding resolution in certain ranges of the input device.

Regardless of how the line is accessed and/or dynamically generated for different pump flow, the line provides full resolution for the input device across the different pump flows. For example, as represented by a third point 417 along the first line 401, upon the operator manipulating the input device to provide the input command of 55 percent during the first pump flow, the valve flow may be 55 percent. Then, as represented by a fourth point 418 along the fourth line 414, upon the operator manipulating the input device to provide the input command of 55 percent during the fourth pump flow, the valve flow may be less than the fourth pump flow. Moreover, further adjustments of the input device to increase the input command during the fourth pump flow will have an effect on the valve flow (e.g., the valve flow will increase up to the fourth pump flow). This is represented by an upward slope of the fourth line 414 between the fourth point 418 and the first point 415 along the fourth line 414. Thus, in this case, the operator may observe movement of the one or more actuators and/or the attachment assembly as the operator manipulates the input device from an intermediate input position (e.g., midway between the minimum input position and the maximum input position) toward the maximum input position even with reduced pump flow (e.g., 50 percent pump flow).

In the dynamic valve map 410, each line 411, 412, 413, 414 is considered to enable the operator to effectively adjust the valve flow through the full range (e.g., the substantially full range) of the input device. The full range may include from the minimum input position that corresponds to zero percent input command to the maximum input position that corresponds to 100 percent input command (e.g., each line 411, 412, 413, 414 has an upward slope along its entire length from the zero percent input command to the 100 percent input command). Or, as shown, the full range may include transition portions 419 (e.g., small inoperable ranges; from zero percent input command to 5 or 10 percent input command; from 90 or 95 percent input command to 100 percent input command) over which manipulation of the input device may not affect the valve flow. In other words, the valve may allow no flow or a minimal flow from zero percent input command to 5 or 10 percent input command and may allow a maximum flow from 90 or 95 percent input command to 100 percent input command. These transition portions 419 may be small enough so as to not cause undue distraction to the operator, and the transition portions 419 may be consistent across all of the different pump flows. In some embodiments, with the dynamic valve map 410, there may not be any inoperable ranges for the input device, or at least no additional or extended inoperable ranges (e.g., beyond transition portions 419) due to the available pump flow.

In operation, during a first time, the controller may receive an indication of the pump flow (e.g., the pump flow during the first time). The controller may determine that the pump flow is greater than a maximum available valve flow. Then, the controller may access the dynamic valve map 410 and select the first line 411 that corresponds to the pump flow. Alternatively, the controller may dynamically generate the first line 411 as set forth herein. Then, the controller may apply the first line 411 to control the valve position of the valve as the operator moves the input device between the minimum input position and the maximum input position.

During a second time, the controller may receive an additional indication of the pump flow (e.g., the pump flow during the second time). The controller may determine that the pump flow is less than a maximum available valve flow. Then, the controller may access the dynamic valve map 410 and select the second line 412 that corresponds to the pump flow. Alternatively, the controller may dynamically generate the second line 412 as set forth herein. Then, the controller may apply the second line 412 to control the valve position of the valve as the operator moves the input device between the minimum input position and the maximum input position.

During a third time, the controller may receive an additional indication of the pump flow (e.g., the pump flow during the third time). The controller may determine that the pump flow is less than a maximum available valve flow. Then, the controller may access the dynamic valve map 410 and select the third line 413 that corresponds to the pump flow. Alternatively, the controller may dynamically generate the third line 413 as set forth herein. Then, the controller may apply the third line 413 to control the valve position of the valve as the operator moves the input device between the minimum input position and the maximum input position. This may continue for different levels of pump flow.

In this way, the dynamic valve map 410 (e.g., a stored dynamic valve map and/or the dynamic mapping process) enables a map (e.g., the relationship) between the valve position (e.g., the valve command from the controller to adjust the valve position) and the input position (e.g., the input command via the input device) to dynamically change based on the pump flow in order to provide improved resolution (e.g., full and/or maximized resolution) of the input device across different pump flows. In other words, at low speeds, the controller remaps the valve command based on the pump flow. Thus, the operator may feel that the work vehicle is responsive to the operator as the operator moves the input device between the minimum input position and the maximum input position without any inoperable ranges (or at least without any extraneous inoperable ranges beyond transition portions) even across the different pump flows. Advantageously, the controller may provide these features without actively controlling the pump flow (e.g., without electronic controls to adjust the pump speed to meet a certain pump flow that then enables a target valve flow from the valve to the actuator) and/or may only use an existing pump flow (e.g., as provided by the pump speed, which is set by the engine speed) as an input to the dynamic mapping process. As used herein, the terms “valve position” and “valve flow” may each be used to describe a state/condition of the valve, as the valve position corresponds to the valve flow. Similarly, the term “valve command” may be used to describe control signals from the controller that cause the valve to be in a particular valve position (e.g., commanded valve position) that corresponds to particular valve flow. Furthermore, the terms “input position” and “input command” may be used to describe a state/condition of the input device, as the input position corresponds to the input command.

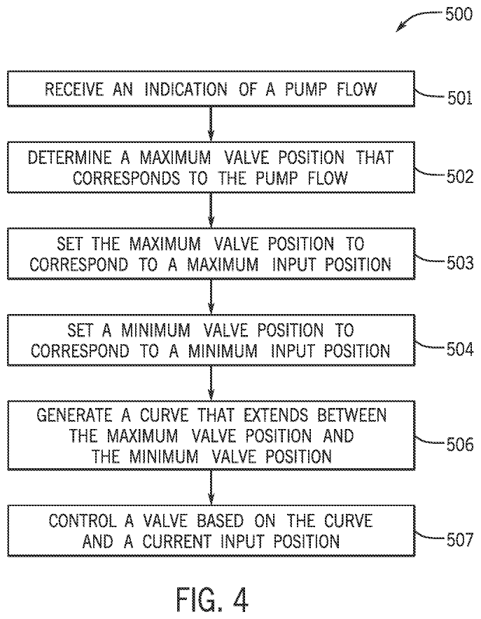

FIG. 4 is a flow chart of a method 500 for operating a work vehicle having the hydraulic circuit shown in FIG. 2 using the dynamic valve map shown in FIG. 3, in accordance with an embodiment of the present disclosure. The following description of the method 500 is described as being performed by a computing system (e.g., the controller 310 of FIG. 2), but it should be noted that any suitable processor-based device or system may be specially programmed to perform any of the methods described herein. Moreover, although the following description of the method 500 is described as including certain steps performed in a particular order, it should be understood that the steps of the method 500 may be performed in any suitable order, that certain steps may be omitted, and/or that certain steps may be added.

In block 501, the method 500 may begin by receiving an indication of a pump flow. The controller may receive the indication of the pump flow from a pump flow sensor that is configured to generate sensor data indicative of the pump flow. The pump flow sensor may be any suitable type of sensor, such as a flow meter along the fluid conduit, a swash plate sensor, a pump speed sensor, and/or an engine speed sensor because a pump speed and the pump flow may vary with an engine speed of an engine of the work vehicle.

In block 502, the method 500 may continue by determining a maximum valve position that corresponds to the pump flow. The controller may determine maximum valve position that corresponds to the pump flow by accessing a look-up table in a memory device, via feedback from one or more flow sensors in the hydraulic control circuit, or via other suitable technique. In block 503, the method 500 may continue by setting the maximum valve position to correspond to a maximum input position for an input device. In block 504, the method 500 may continue by setting a minimum valve position to correspond to a minimum input position for the input device.

In block 505, the method 500 may continue by generating a curve that extends between the maximum valve position and the minimum valve position. The curve may be linear, curved, or have any suitable shape that provides desirable resolution of the input device (e.g., across a full range of the input device). In block 506, the method 500 may continue by controlling a valve based on the curve and a current input position of the input device. In this way, the controller identifies the curve that enables adjustment to a relationship between the valve position (e.g., the valve command from the controller to adjust the valve position) and the input position (e.g., the input command via the input device) based on the pump flow.

While only certain features have been illustrated and described herein, many modifications and changes will occur to those skilled in the art. It is, therefore, to be understood that the appended claims are intended to cover all such modifications and changes as fall within the true spirit of the disclosure. It should be appreciated that any features described with respect to FIGS. 1-4 may be combined in any suitable manner.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A hydraulic control system for a work vehicle, the hydraulic control system comprising:
one or more processors configured to:
receive an indication of a pump flow provided by a pump of the hydraulic control system;
receive an additional indication of a current input position of an input device of the hydraulic control system; and
apply a dynamic valve map to control a valve position of a valve of the hydraulic control system based on the pump flow and the current input position of the input device.

2. The hydraulic control system of claim 1, comprising a memory device configured to store the dynamic valve map.

3. The hydraulic control system of claim 2, wherein the dynamic valve map comprises a first line that corresponds to the pump flow and a second line that corresponds to a different pump flow.

4. The hydraulic control system of claim 3, wherein the one or more processors is configured to apply the dynamic valve map to control the valve position of the valve based on the pump flow and the current input position by selecting the first line and controlling the valve position of the valve according to the first line and the current input position.

5. The hydraulic control system of claim 1, wherein the one or more processors are configured to:
determine a maximum valve position that corresponds to the pump flow;
set the maximum valve position to correspond to a maximum input position of the input device;
set a minimum valve position to correspond to a minimum input position of the input device;
set a line that maps the valve position across different input positions, wherein the line extends between the maximum valve position and the minimum valve position; and
apply the dynamic valve map to control the valve position of the valve based on the pump flow and the current input position by controlling the valve position of the valve according to the line and the current input position.

6. The hydraulic control system of claim 1, wherein the one or more processors are configured to:
receive a further indication of a different pump flow provided by the pump of the hydraulic control system; and
apply the dynamic valve map to control the valve position of the valve of the hydraulic control system based on the different pump flow and the current input position of the input device.

7. The hydraulic control system of claim 6, wherein the dynamic valve map is configured to enable adjustment of the valve position of the valve over a full range of the input device during the pump flow and during the different pump flow.

8. The hydraulic control system of claim 1, wherein the pump flow is less than a maximum valve flow of the valve.

9. The hydraulic control system of claim 1, comprising an actuator coupled to the work vehicle and configured to drive movement of an attachment assembly, wherein the valve is configured to provide a flow of fluid to the actuator to cause the movement of the attachment assembly.

10. A hydraulic control system for a work vehicle, the hydraulic control system comprising:
one or more processors configured to:
receive an indication of a pump flow provided by a pump of the hydraulic control system;
determine a maximum valve position that corresponds to the pump flow;
set the maximum valve position to correspond to a maximum input position;
set a minimum valve position to correspond to a minimum input position;
set a line that maps a valve position across different input positions, wherein the line extends between the maximum valve position and the minimum valve position;
receive a current input position for an input device; and
control a valve according to the line and the current input position.

11. The hydraulic control system of claim 10, wherein the one or more processors enable adjustment of the valve position over a full range of the input device during the pump flow.

12. The hydraulic control system of claim 10, wherein the pump flow is less than a maximum valve flow of the valve.

13. The hydraulic control system of claim 10, wherein the one or more processors are configured to:
receive an additional indication of a different pump flow provided by the pump of the hydraulic control system;
determine an additional maximum valve position that corresponds to the different pump flow;
set the additional maximum valve position to correspond to the maximum input position;
set the minimum valve position to correspond to the minimum input position;
set an additional line that maps the valve position across different input positions, wherein the additional line extends between the additional maximum valve position and the minimum valve position; and
control the valve according to the additional line and the current input position.

14. The hydraulic control system of claim 10, comprising an actuator coupled to the work vehicle and configured to drive movement of an attachment assembly, wherein the valve is configured to provide a flow of fluid to the actuator to cause the movement of the attachment assembly.

15. A method of operating a hydraulic control system for a work vehicle, the method comprising:
receiving, at one or more processors, an indication of a pump flow being provided by a pump of the hydraulic control system;
receiving, at the one or more processors, an additional indication of a current input position of an input device of the hydraulic control system; and
applying, using the one or more processors, a dynamic valve map to control a valve position of a valve of the hydraulic control system based on the pump flow and the current input position of the input device.

16. The method of claim 15, comprising:
receiving, at the one or more processors, a further indication of a different pump flow provided by the pump of the hydraulic control system; and
applying, using the one or more processors, the dynamic valve map to control the valve position of the valve of the hydraulic control system based on the different pump flow and the current input position of the input device.

17. The method of claim 15, comprising:
receiving, at the one or more processors, a further indication of a change to the current input position of the input device of the hydraulic control system; and
applying, using the one or more processors, the dynamic valve map to control the valve position of the valve of the hydraulic control system based on the pump flow and the change to the current input position of the input device.

18. The method of claim 17, wherein applying, using the one or more processors, the dynamic valve map to control the valve position of the valve of the hydraulic control system based on the pump flow and the change to the current input position of the input device enables adjustment the valve position of the valve over a full range of the input device.

19. The method of claim 15, comprising:
determining, using the one or more processors, a maximum valve position that corresponds to the pump flow;
setting, using the one or more processors, the maximum valve position to correspond to a maximum input position of the input device;
setting, using the one or more processors, a minimum valve position to correspond to a minimum input position of the input device;
setting, using the one or more processors, a line that maps the valve position across different input positions, wherein the line extends between the maximum valve position and the minimum valve position; and
applying, using the one or more processors, the dynamic valve map to control the valve position of the valve based on the pump flow and the current input position by controlling the valve position of the valve according to the line and the current input position.

20. The method of claim 19, comprising applying, using the one or more processors, the dynamic valve map as the work vehicle conducts work operations at a work site.
